(19) United States
(12) Patent Application Publication
(10) Pub. No.: US 2003/0145839 A1
(43) Pub. Date: Aug. 7, 2003

(54) Pressure releasing valve capable of reserving air pressure

(76) Inventor: Chiang Fu. Wu, Tainan City (TW)

Correspondence Address: CHIANG FU. WU, P.O. BOX 2-10, TAINAN CITY, TW

(21) Appl. No.: 10/072,232

(22) Filed: Feb. 4, 2002

(51) Int. Cl. F02M 23/00

(52) U.S. Cl. 123/587

(57) ABSTRACT

A pressure releasing valve capable of reserving air pressure is formed with a pressure reserving chamber to retain a proper amount of air pressure in the pressure releasing valve when the engine is changing from an accelerating and increasing pressure condition to a condition of running idly and releasing pressure, so that when the engine accelerates and increases pressure again, air of the condenser can be continually supplied for the engine to let it run comparatively smoothly in accelerating, not only economizing energy but ensuring safety as well.

### BACKGROUND OF THE INVENTION

This invention relates to a pressure-releasing valve, particularly to one capable of reserving air pressure in the condenser of an automobile engine when the engine is changing from a condition of accelerating and increasing pressure to a condition of running idly and releasing pressure, so that when accelerating again, the engine can be supplied with air pressure in time to run smoothly, having functions of economizing oil and ensuring safety.

A conventional air-conditioning system of an automobile engine, as shown in FIG. 1, includes an air sucking tube (A), a pressure increasing member (B), a condenser (C), an engine (D) and a pressure releasing valve (E) combined together.

The air sucking tube (A) is connected to the pressure increasing member (B), the pressure increasing member (B) is connected to the condenser (C) through an air tube (BO), and the condenser (C) is connected to the engine (D) through an air tube (CO). The pressure- releasing valve (E) is provided between the engine (D) and the air sucking tube (A) as well as the air tube (BO), and connected to the engine (D) through a small air tube (DO).

The pressure-releasing valve (E), as shown in FIGS. 2 and 3, includes a valve body (EO) with two outlets (E1) and (E2), and a valve (E3) inside able to close up the outlets (E1), (E2) at the same time. The valve (E3) is provided inside with a spring (E4) and a spring chamber (E5) with an inlet (E6). Thus, when the engine (D) is changing from a condition of accelerating and increasing pressure to a condition of running idly and releasing pressure, it will produce a proper sucking force to suck open the valve (E3) through the small air tube (DO), as shown in FIG. 2, letting the air sucked by the air sucking tube (A) circulate in a direction indicated by the arrow (R1) in FIG. 1. On the contrary, when accelerating, the engine (D) no longer has a sucking force, so the valve (E3) is closed up by the resiliency of the spring (B4), as shown in FIG. 3, letting the air run in a direction indicated by the arrow (R2) in FIG. 1 and then get into the engine (D) to cool it down.

However, when such a conventional pressure-releasing valve (E) is in a condition of oil return, it will completely release the air out so no air pressure remains inside the condenser (C). Under such condition, it may take a little time (less than a second) to let the condenser (C) filled up with air, which then gets in the engine (D) to enable the engine (D) to work smoothly in case of gear shifting or accelerating. Such breaking off of air pressure caused in the period of shifting gears or stepping on an accelerator will delay accelerating or starting the engine, resulting in danger in driving and wasting energy.

Although delay time is only a fraction of s second, there are many times of shifting gears, consumed energy may be not to be ignored.

Besides, when a car is running with high speed and if there happens a delay in accelerating, a driver may make wrong judgment to cause danger.

### SUMMARY OF THE INVENTION

The objective of the invention is to offer an engine capable to keep the condenser of an automobile engine filled up with air pressure when the engine is changing from a condition of accelerating to a condition of running idly, so that the engine can be supplied with air pressure in time to run smoothly, having functions of saving oil and ensuring safety in driving when accelerating again.

The feature of the invention is that a pressure- reserving chamber is provided inside a pressure- releasing valve. The pressure-reserving chamber can retain a proper amount of air pressure when the engine is changing from a condition of accelerating and increasing pressure to a condition of running idly and releasing pressure, so that when the engine starts accelerating again, air pressure can be supplied in time for the engine to run smoothly.

### BRIEF DESCRIPTION OF DRAWINGS

This invention will be better understood by referring to the accompanying drawings, wherein:

FIG. 1 is a cross-sectional view of a conventional air conditioning system of an automobile engine;

FIG. 2 is a cross-sectional view of a conventional pressure-releasing valve in a condition of oil return and pressure releasing;

FIG. 3 is a cross-sectional view of the conventional pressure-releasing valve in a condition of accelerating and increasing pressure;

FIG. 4 is a cross-sectional view of an air conditioning system in the present invention;

FIG. 5 is an exploded perspective view of a pressure-releasing valve in the present invention;

FIG. 6 is side cross-sectional view of the pressure-releasing valve in the present invention;

FIG. 7 is a cross-sectional view of the pressure- releasing valve in a condition of accelerating and increasing pressure in the present invention;

FIG. 8 is a cross-sectional view of the pressure releasing valve in a condition of oil return and releasing pressure and idly running in the present invention;

FIG. 9 is a cross-sectional view of the pressure- releasing valve in a condition of the engine running idly in the present invention.

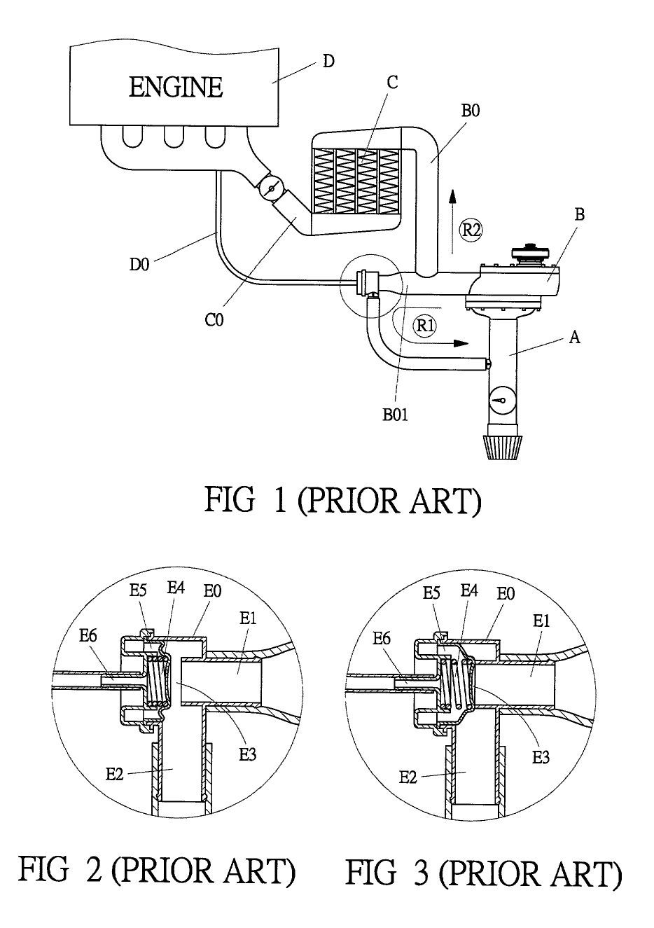

### DETAILED DESCRIPTION OF THE PREFERRED EMBODIMENT

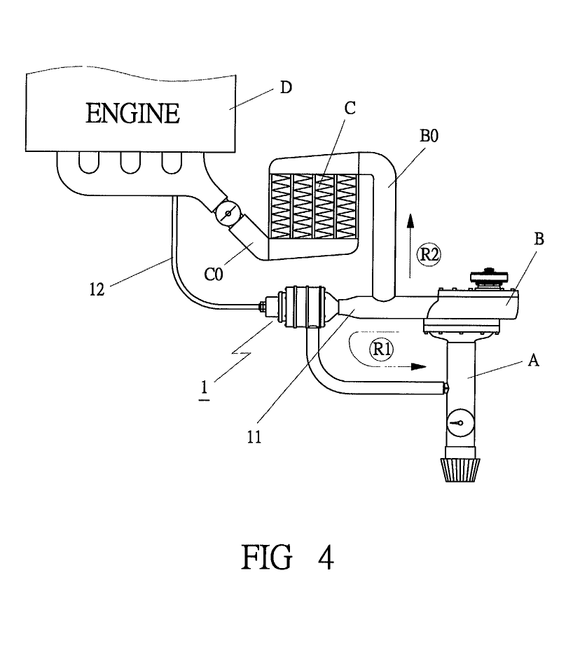

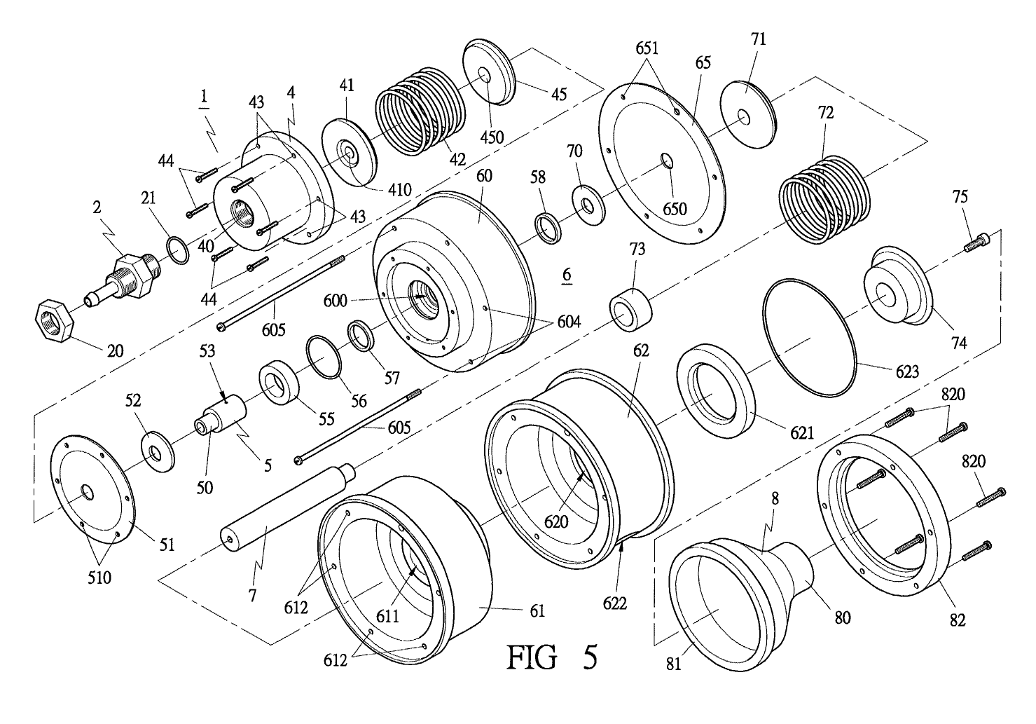

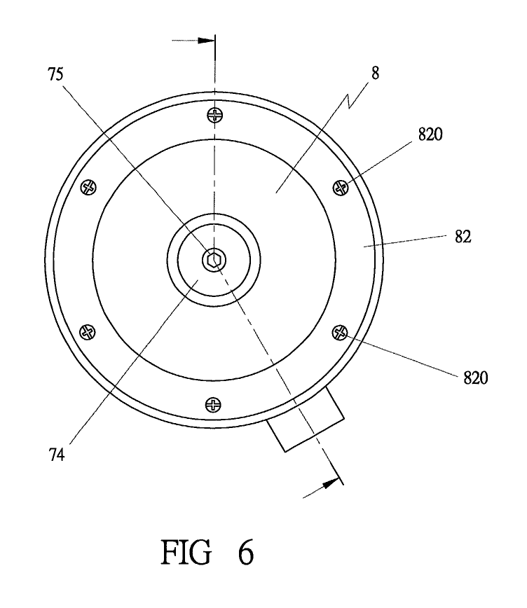

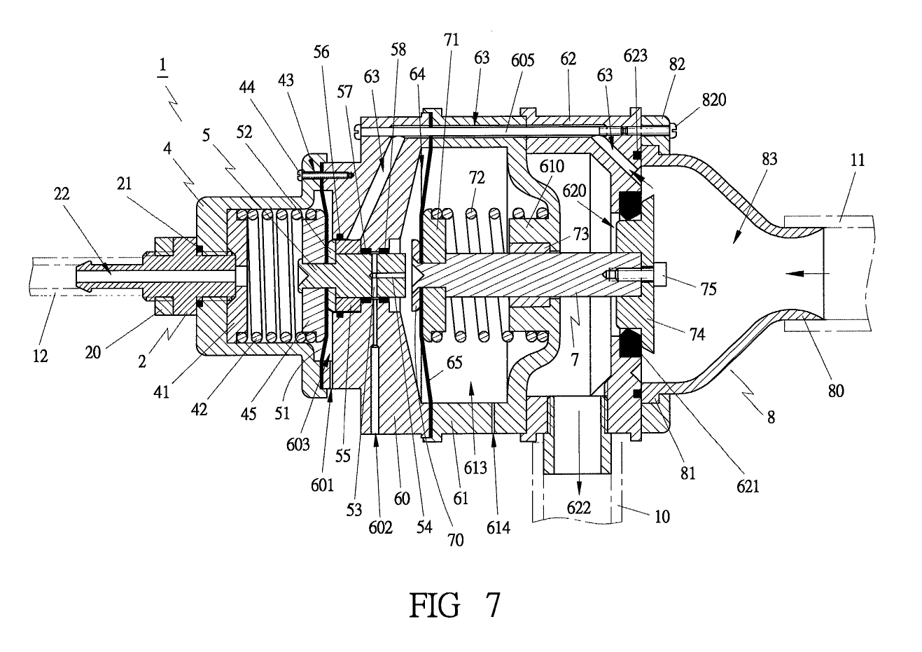

A preferred embodiment of a pressure releasing valve in the present invention, as shown in FIG. 4, includes an air tube connecter 2, a left cover 4, an air chamber holder 5, a casing 6 and a right cover 8 as main components combined together.

The air tube connecter 2 is crewed with a nut 20 on the outer surface and formed with male threads around the right end to be engaged with a female threaded hole 40 of the left cover 4. The air tube connecter 2 is connected to a pressure return tube 12 and fitted with an O-shaped gasket 21 to prevent leaking.

The left cover 4 is formed with a chamber 420 for receiving a left and a right stop member 41 and 45 and a spring 42, having a plurality of bolt holes around an outer side for bolts 44 to pass therethrough and be fixed with a left casing 60. Then, the left and right stop members 41 and 45 respectively having a central hole 410, 450 are provided on the opposite sides of the spring 42, with the central hole 410 of the left stop member 41 aligned with the central hole 22 of the air tube connecter 2. Thus, when the engine is in a condition of oil return, the air in the chamber 420 of the left cover 4 will be pumped out through the pressure return tube 12, and the spring 42 will be pressed by the right stop member 45 which has its central hole 450 inserted through by a small rod 50 of the air chamber holder 5.

In addition, a first valve strip 51 is tightly sandwiched by the right stop member 45 and a gasket 52 of the air chamber holder 5, having a plurality of small holes 510 formed around its circumferential edge for the bolts 44 to be inserted therethrough to make the first valve strip 5 fixedly sandwiched by the left cover 4 and a left casing 60, letting the air in the chamber 420 come in or go out through only one opening.

The air chamber holder 5 is provided with a lengthwise through hole 53 and a lateral hole 54. After the air chamber holder 5 is fitted around with a sleeve 55 and an O-shaped ring 56, it is fitted with two leakage preventive rings 57 and 58 between opposite opening of the lengthwise through hole 53. Then, the O-shaped ring 56 and the leakage preventive rings 57, 58 are positioned in the central hole 600 inside the left casing 60, which is for receiving the air chamber holder 5.

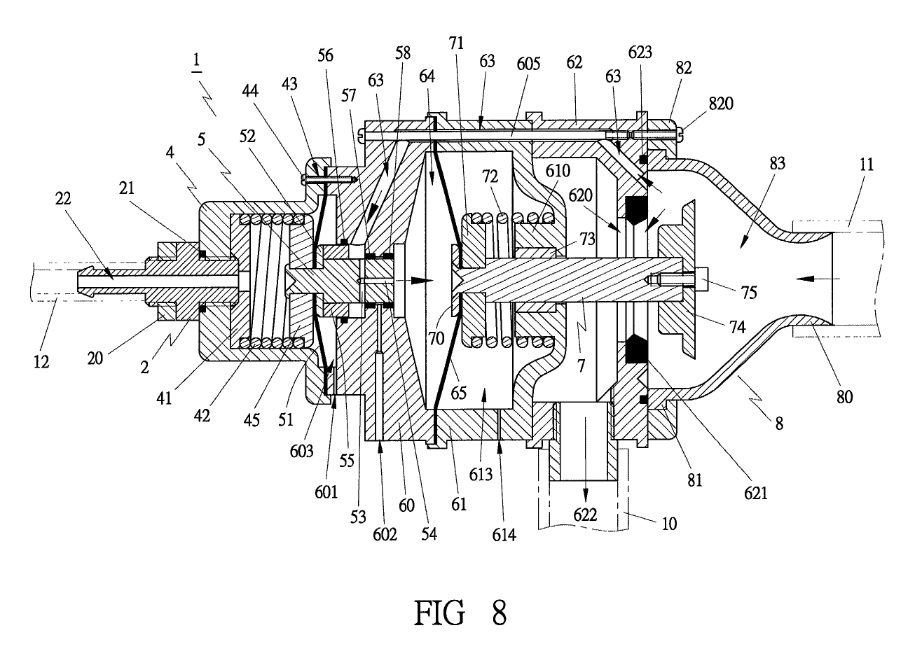

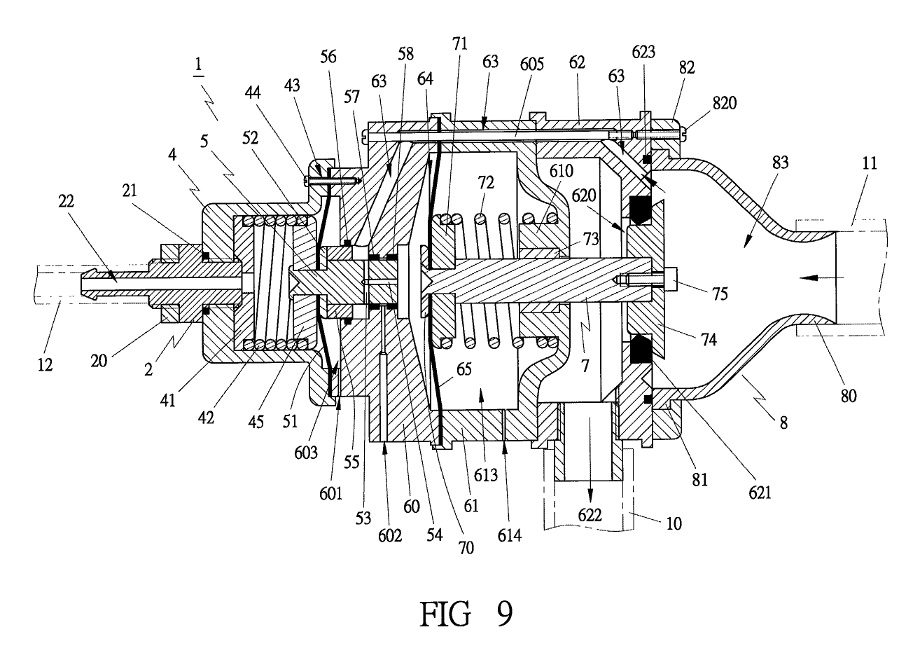

The casing 6 consists of a left casing 60, an intermediate casing 61 and a right casing 62. These three casings 60, 61 and 62 are respectively provided with an air intake passage 63 communicating with one another. The left casing 60 further has two air releasing passages 601 and 602, with the air releasing passage 601 positioned at the right side of the first valve strip 51 to keep the air in the right side chamber 603 of a first valve sheet 51 in a circulating condition and let the first valve sheet 51 operate smoothly. The air releasing passage 602 can communicate with the lengthwise hole 53 of the air chamber holder 5 when accelerating and increasing pressure so as to pump out the air in the pressure reserving chamber 64, but during oil return and releasing pressure, the air releasing passage 602 can not communicate with the lengthwise hole 53, as shown in FIGS. 8 and 9. Besides, the left casing 60 is bored with a plurality of boltholes 604 for long bolts 605 to pass through and combine three casings 60, 61 and 62 together.

Further, a second valve sheet 65 is sandwiched between the left casing 60 and the intermediate casing 61, with a pressure-reserving chamber 64 formed between the second valve sheet 65 and the left casing 60. The second valve sheet 65 is formed with a central hole 650 for a shaft rod 7 to be inserted therein, and a plurality of small holes 651 around the circumferential edge for the long bolts 605 to be inserted therethrough. The shaft rod 7 is provided between the intermediate casing 61 and the right casing 62, having its left end inserted through the second valve sheet 65 and then fixed by a gasket 70. Then, a left stop member 71 and a spring 72 are orderly provided on the right side of the second valve sheet 65, with the spring 72 fitted in the spring holder 610 of the intermediate casing 61. The shaft rod 7 is further fitted around with a sleeve 73 to be positioned in the central hole 611 of the intermediate casing 61, having its right end combined with a right stop member 74 and secured together by a bolt 75. The right stop member 74 is fixed in the central hole 620 of the right casing 62 and pushed against by a leakage preventive ring 621. The intermediate casing 61 has an air releasing passage 614 to let the air of the spring holder 613 communicate with external air, and a plurality of bolt holes 612 for the long bolts 605 to be screwed therethrough. Then, the right casing 62 is provided with a circulation tube opening 622 to be connected with an air tube 10.

The right cover 8 is formed with a connecter 80 for receiving an air tube 11, and provided with a circular rim 81 to be mounted around with a ring 82 fixed with the right casing 62 by means of bolts 820, with a O-shaped gasket 623 closely fitted between the right cover 8 and the right casing 62 to prevent leaking.

When the engine of this invention is in a condition of accelerating and increasing pressure, as shown in FIG. 7, the cool air pumped in will move in a direction indicated by the arrow R2 in FIG. 4 and the pressure-releasing valve 1 is in a silent condition.

When the accelerator is released, and the engine gives rise to oil return and pressure releasing, as shown in FIG. 8, the air of the air-conditioning system will circulate in a direction indicated by the arrow R1 in FIG. 4 and get into the pressure reserving chamber 64 through the air chamber 83 of the right cover 62, through the air intake passage 63, and through the lengthwise through hole 53 and the lateral hole 54 of the air chamber holder 5. At this time, the air pressure in the pressure reserving chamber 64 is large enough (more than 0.2 kg) to press the second valve 65 and move the right stop member 74 of the shaft rod 7 to make the central hole 620 of the right casing 62 opened so as to let the air get out of the air tube 10 through the central hole 620.

In case the engine runs more and more slowly to idly, it will produce a sucking force toward the chamber 420 through the pressure return tube 12 and force the first valve sheet 51 to move forward together with the air chamber holder 5. Thus, the air intake passage 63 can communicate with the pressure reserving chamber 64 through the air chamber holder 5, and at this time, the central hole 620 of the right casing 62 is closed, because the air pressure in the pressure reserving chamber 64 is less than 0.2 kg, as shown in FIG. 9. The remaining air in the pressure reserving chamber 64 lets the condenser keep a certain amount of air pressure inside, therefore every time the engine accelerates and increases pressure, as shown in FIG. 7, the condenser can immediately supply the engine with air to enable the engine run smoothly all the time, having functions of saving oil and elevating efficiency of an engine.

While the preferred embodiment of the invention has been described above, it will be recognized and understood that various modifications may be made therein and the appended claims are intended to cover all such modifications that may fall within the spirit and scope of the invention.

What is claimed is:

1. A pressure releasing valve capable of reserving air pressure comprising an air tube connecter, a left cover, a first valve trip, an air chamber holder, a second valve trip, a casing, a shaft rod and a right cover;
Said left cover provided inside with a chamber for receiving a left stop member, a right stop member and a spring, said spring sandwiched between said left and right stop members, a first valve sheet mounted on the rear side of said right stop member and sandwiched by a gasket of said air chamber holder and said right stop member;
Said air chamber holder having a lengthwise through hole and a lateral hole, said air chamber holder fitted around with a sleeve and an O-shaped ring, said air chamber holder fitted around with two leakage preventive rings between opposite openings of said lengthwise through hole;
Said casing consisting of a left casing, an intermediate casing and a right casing, said three casings respectively formed with an air intake passage communicating with one another, said three casings combined together by means of long bolts;
A second valve sheet sandwiched by said left casing and said intermediate casing, with a pressure reserving chamber formed between said second valve strip and said left casing;
Said shaft rod positioned between said intermediate casing and said right casing, said shaft rod having its left end inserted through said second valve sheet and fixed by a ring, a left stop member and a spring orderly disposed on the right side of said second valve sheet, said spring having one end fitted in the spring holder of said intermediate casing, said shaft rod fitted around with a sleeve to be fitted in the central hole of said intermediate casing, said shaft rod having its right end combined with a right stop member and tightly secured together by a bolt, said right stop member deposited in the central hole of said right casing and resisted by a leakage preventive ring;
Said right side cover provided with an air tube connecter on the right side and a circular rim on the left side for a ring to be mounted around and fixed therein, said circular rim combined with said right casing by means of bolts.

2. The pressure releasing valve capable of reserving air pressure as claimed in claim 1, wherein said pressure releasing valve is formed with a pressure reserving chamber able to keep a proper amount of air pressure in said pressure reserving valve when the engine is changing from an accelerating and increasing pressure condition to a condition of running idly and releasing pressure, so that the condenser can in time supply air for the engine to let it run smoothly in accelerating when said engine accelerates and increases pressure again.

3. The pressure releasing valve capable of reserving air pressure as claimed in claim 1 or 2, wherein said left stop member and said right stop member respectively has a central hole, and the central hole of said left stop member is aligned with the central hole of said air tube connecter, so that when the engine is in a condition of oil return, the air in said chamber can be pumped out through said pressure return tube, with said right stop member pressing said spring.

4. The pressure releasing valve capable of reserving air pressure as claimed in claim 1 or 2, wherein said left casing has an air releasing passage provided on the right side of said first valve sheet to keep the air in the right side chamber of said first valve sheet flowing, and the said air releasing passage can communicate with said lengthwise through hole of said air chamber holder so as to release the air out of said pressure reserving chamber when accelerating and increasing pressure.

5. The pressure releasing valve capable of reserving air pressure as claimed in claim 1 or 2, wherein said second valve sheet has a central hole for said shaft rod to be inserted therethrough, and a plurality of small holes on a circumferential edge for said long bolts to screw through.

6. The pressure releasing valve capable of reserving air pressure as claimed in claim 1 or 2, wherein said intermediate casing is formed with an air releasing passage to let the air of said spring holder communicate with external air.
